(19) United States
(12) Patent Application Publication
(10) Pub. No.: US 2026/0312091 A1
(43) Pub. Date: Oct. 8, 2026

(54) FUEL CELL SYSTEM AND PURGING METHOD FOR INERTING A FUEL CELL SYSTEM

(71) Applicant: Robert Bosch GmbH, Stuttgart (DE)

(72) Inventors: Christophe Billmann, Stuttgart (DE); Timo Bosch, Renningen (DE); Tobias Falkenau, Esslingen (DE)

(21) Appl. No.: 19/108,225

(22) PCT Filed: Sep. 13, 2023
(86) PCT No.: PCT/EP2023/075119

§ 371 Date: Mar. 3, 2025

(30) Foreign Application Priority Data
Sep. 14, 2022 (DE) 10 2022 209 602.9

(51) Int. Cl. H01M 8/04223; H01M 8/04119; H01M 8/0438; H01M 8/0444; H01M 8/04746

(52) U.S. Cl. CPC H01M 8/04231; H01M 8/04156; H01M 8/04388; H01M 8/0447; H01M 8/04776

(57) ABSTRACT

The invention relates to a fuel cell system (1) comprising a fuel cell stack (2) having an anode side (3) with an anode circuit (4), and a cathode side (5) with a cathode circuit (6), a nitrogen tank (7) for providing nitrogen for inerting the fuel cell system (1), a nitrogen supply line (8) having a first valve device (9) for adjusting the supply of nitrogen from the nitrogen tank (7) to the anode side (3), and a pressure sensor (10), in particular a nitrogen pressure sensor, for adjusting a target pressure (p_{Target}) to the anode side (3), wherein a control device (11) of the fuel cell system (1) is configured to control the first valve device (9) such that there can be cyclical switching between an ambient pressure (p_{amb}) and a maximum target pressure (p_{Target}), a gas conveying device (12), which is configured to actively convey the nitrogen coming from the nitrogen tank (7) to the anode side (3) of the fuel cell stack (2) via the first valve device (9), a water discharge line (13) having a second valve device (14) for discharging separated water from a first water separator (15) of the gas conveying device (12) of the anode circuit (4) into an waste gas line (16) of the cathode circuit (6).

### BACKGROUND

The invention relates to fuel cell system having the features of the disclosure. Furthermore, the invention relates to a purging method for inerting a fuel cell system with nitrogen having the features of the disclosure.

Polymer electrolyte membrane (PEM) fuel cell systems convert hydrogen by means of oxygen into electrical energy, generating waste heat and water. The conversion of hydrogen is equivalent to hydrogen molecules being consumed or removed on the anode side.

The PEM fuel cell consists of an anode supplied with hydrogen, a cathode supplied with air, and the polymer electrolyte membrane placed between the two. A plurality of such individual fuel cells are stacked in practical application to increase the generated electric voltage. Within this fuel cell stack are supply channels that supply hydrogen and air to the individual cells and remove the depleted moist air as well as the depleted anode waste gas.

Moisture separators are specifically used to separate liquid water from the gaseous portion of the anode waste gas. In addition to the separation function, the separator also has the task of storing the separated water. If the accumulator is full, the water is discharged by means of the opening of a so-called discharge valve.

Nitrogen can enter the anode chamber through diffusion processes. A further source of nitrogen is the fresh fuel, which is not 100% pure hydrogen. Nitrogen represents an inert gas for the fuel cell, reducing the cell voltage and thus the stack voltage, which in turn results in a loss of efficiency. Therefore, gas is discharged repeatedly from the anode chamber during a travel cycle in order to reduce the nitrogen content. This discharge is carried out with the so-called vent valve.

According to the prior art, fresh hydrogen is supplied by means of hydrogen metering valves, which can be configured as proportional valves. The control strategy provides that this valve be used to regulate the gas pressure within an anode path, measured by a pressure sensor at a defined position, to a defined target pressure depending on the system operating point.

In order for the unused hydrogen to be reused, the anode is constructed according to the prior art in a closed circuit. To provoke the gas mixture to recirculate, a fan is installed in the anode circuit.

Between the hydrogen tank and the hydrogen metering valves are other valves, lines and a pressure reducer. These have the task of safely separating the hydrogen tank from the anode and adjusting the hydrogen pressure to the operating pressure of the hydrogen metering valves. If a system has two water reservoirs (main water separator and gas conveying device) both function as a discharge valve and one additionally assumes the task of a vent valve.

Due to the system, a hydrogen sensor is located in the waste gas path of the cathode air downstream of the inlet points of the vent valve and the discharge valve. When anode gas enters the waste gas path of the cathode air, this is detected at the hydrogen sensor.

### SUMMARY

A fuel cell system as well as a purging method with the features of the disclosure is disclosed. Further features and details of the invention arise from the dependent claims, the description, and the drawings. In this context, features and details described in connection with the fuel cell system according to the invention clearly also apply in connection with the purging method according to the invention, and respectively vice versa, so that mutual reference to the individual considerations of the invention always is or can be made with respect to the disclosure.

According to the invention, a fuel cell system is provided comprising a fuel cell stack having an anode side with an anode circuit, and a cathode side with a cathode circuit, a nitrogen tank for providing nitrogen for inerting the fuel cell system, a nitrogen supply line having a first valve device for adjusting the supply of nitrogen from the nitrogen tank to the anode side, and a pressure sensor, in particular a nitrogen pressure sensor, for adjusting a target pressure to the anode side, wherein a control device of the fuel cell system is configured to control the first valve device such that there can be cyclical switching between an ambient pressure and a maximum target pressure, a gas conveying device, which is configured to actively convey the nitrogen coming from the nitrogen tank to the anode side of the fuel cell stack via the first valve device, a water discharge line having a second valve device for discharging separated water from a first water separator of the gas conveying device of the anode circuit into an waste gas line of the cathode circuit.

Here, the fuel cell stack comprises a plurality of fuel cells that can be inerted by means of the fuel cell system according to the invention.

Prior to maintenance, all lines and components that are in contact with hydrogen must be purged and replaced with nitrogen, meaning that the fuel cell system must be inerted. This is necessary, for example, so that little hydrogen comes into contact with ambient air when dismantling the fuel cell system in order to reduce the risk of combustion or explosion. By inerting the fuel cell stack, in addition to avoiding the risk of combustion and explosions, its potentially hazardous electric voltage is also reduced.

Inerting thus establishes and significantly increases the safety for performing maintenance on a fuel cell system.

By cyclically switching between an ambient pressure and a maximum target pressure by controlling the first valve device via the control device of the fuel cell system, a type of pulsing of the gas flow is generated. This increases the efficiency and the speed at which the nitrogen replaces the hydrogen. It thus increases the efficiency of inerting the fuel cell system.

During normal operation, the gas conveying device conveys hydrogen into the fuel cell system. In this case, it may be advantageous if hydrogen flows through the nitrogen supply line, the first valve device and the pressure sensor, in particular a nitrogen pressure sensor, during normal operation. Accordingly, the nitrogen supply line is then the hydrogen supply line and the first valve device is the hydrogen metering valve.

In the context of the invention, it may be advantageous that a third valve device is provided for discharging anode gas from a first water separator of the gas conveying device of the anode circuit into a waste gas line of the cathode circuit.

The anode gas, which can be discharged via the third valve device, can thereby serve to discharge the hydrogen. Furthermore, it is contemplated to evaluate the discharged anode gas to determine how much nitrogen is already in the fuel cell system. This represents the effectiveness of the purging, which in turn increases the safety during a maintenance operation.

It is further contemplated that the third valve device corresponds to the vent valve of the fuel cell system through which hydrogen flows. This dual use of the valve device ensures a simple and favorable set-up of the fuel cell system. Furthermore, this reduces possible leaks in the fuel cell system.

Furthermore, it is contemplated that a second water separator is provided. This then initially separates a first part of the water and delivers the remaining anode gas to the gas conveying device or the first water separator of the gas conveying device. The third valve device is thereby associated with the second water separator. And another valve device is contemplated to discharge the water into the waste gas line of the cathode circuit.

In the context of the invention, it is contemplated that a hydrogen sensor is provided in the waste gas line of the cathode circuit.

The content of hydrogen in the separated anode gas can be determined by means of the hydrogen sensor. A low or decreasing content of hydrogen in the anode gas indicates that the fuel cell system will be or is inerted. This helps to determine safety for maintenance in a more efficient way. At the same time, the duration of the inerting process can be determined.

A second aspect of the invention is a purging method for inerting a fuel cell system with nitrogen described above, comprising the steps of:
switching a gas source of the anode circuit of the fuel cell stack from hydrogen to nitrogen,
commissioning the gas conveying device, in particular a flow compressor, for conveying nitrogen in the anode circuit,
commissioning the cathode circuit for generating the diluting air in the waste gas,
opening the first valve device in the nitrogen supply line of the anode circuit,
adjusting the target pressure by means of the first valve device of the nitrogen supply line on the anode side of the fuel cell stack,
opening the second valve device of the water discharge line of the anode circuit for discharging the separated water of the first water separator of the gas conveying means into the waste gas line of the cathode circuit,
cyclical switching of the target pressure, wherein the target pressure is switched between the maximum target pressure and the ambient pressure and/or cyclical switching of the gas conveying device on and off.

Here, the fuel cell stack comprises a plurality of fuel cells that can be inerted by means of the fuel cell system according to the invention.

Prior to maintenance, all lines and components that are in contact with hydrogen must be purged and replaced with nitrogen, meaning that the fuel cell system must be inerted. This is necessary, for example, so that little hydrogen comes into contact with ambient air when dismantling the fuel cell system in order to reduce the risk of combustion or explosion. By inerting the fuel cell stack, in addition to avoiding the risk of combustion and explosions, its potentially hazardous electric voltage is also reduced.

Inerting thus establishes and significantly increases the safety for performing maintenance on a fuel cell system.

By cyclically switching between an ambient pressure and the maximum target pressure by controlling the first valve device via the control device of the fuel cell system, a type of pulsing of the gas flow is generated. This increases the efficiency and the speed at which the nitrogen replaces the hydrogen. It thus increases the efficiency of inerting the fuel cell system.

During normal operation, the gas conveying device conveys hydrogen into the fuel cell system. In this case, it may be advantageous if hydrogen flows through the nitrogen supply line, the first valve device and the pressure sensor, in particular a nitrogen pressure sensor, during normal operation. Accordingly, the nitrogen supply line is then the hydrogen supply line and the first valve device is the hydrogen metering valve.

The first water separator can be seen here as a part of the gas conveying device. This is used to withdraw water from the anode gas as far as possible, both during normal operation and during the purging method. The water is discharged into the waste gas line of the cathode circuit via the second valve device.

The nitrogen may be provided from a line or a compressed gas cylinder. If it is provided via a compressed gas cylinder, the start-up of the gas conveying device for conveying nitrogen in the anode circuit is obsolete.

Before anode gas, which may potentially contain a lot of hydrogen, is directed into the cathode waste gas, the cathode system in which the corresponding gas conveying device is started must also be started. As a result, dilution air is provided in the waste gas.

It may be contemplated in the context of the invention that the cyclical switching is performed at an alternating frequency, wherein the alternating frequency is 0.5 to 10 Hz, preferably 2 to 8 Hz, further preferably 3 to 7 Hz.

The alternating frequency can easily influence the cycle of the purging method. The alternating frequency thus directly influences the efficiency and speed of the purging method or inerting the fuel cell system. The higher the frequency, the faster the cycle change and the more effective the purging method. Furthermore, the alternating frequency may be dynamic to address changes in the fuel cell system. The alternating frequency can be adjusted, for example, depending on the content of the nitrogen in the fuel cell system.

It is further contemplated that cyclical switching between different operating states of the gas conveying device is performed.

For this purpose, the gas conveying device has different power levels, between which it is possible to switch. A cyclical change of the operating states of the gas conveying device can also be the cyclical switching of the gas conveying device on and off.

By switching the operating conditions, i.e. the power levels of the gas conveying device, it is possible to easily influence the cycle of the purging method. The alternating frequency thus directly influences the efficiency and speed of the purging method or inerting the fuel cell system. The higher the frequency, the faster the cycle change and the more effective the purging method. Furthermore, the alternating frequency may be dynamic to address changes in the fuel cell system. The alternating frequency can be adjusted, for example, depending on the content of the nitrogen in the fuel cell system.

It is contemplated according to the present invention that the maximum target pressure is adjusted relative to the ambient pressure, wherein the target pressure is set at 0.3 to 5 bar, preferably 1 to 4 bar, further preferably 1.5 to 3 bar, relative to the ambient pressure, and/or adjusted relative to the cathode pressure, wherein the target pressure (p_{Target}) deviates by a maximum of 1 bar from the cathode pressure.

The relative pressure between the anode and the cathode may be a limitation. The relative pressure is limited to 0.8 to 1.2 bar for a duration of 10 s. It would thus be contemplated that during the inerting process, the pressure in the cathode subsystem will be built up so that the pressure in the anode can be absolutely increased.

The target pressure may be dependent on the particular fuel cell system, the nitrogen content in the fuel cell system, or the alternating frequency. Accordingly, it is contemplated that the target pressure can be dynamically adjusted and can be changed during the purging method.

It is also contemplated that the third valve device of the water discharge line of the anode circuit is opened to discharge the anode gas of the first water separator of the gas conveying device into the waste gas line of the cathode circuit.

The anode gas, which can be discharged via the third valve device, can thereby serve to discharge the hydrogen. Furthermore, it is contemplated to evaluate the discharged anode gas to determine how much nitrogen is already in the fuel cell system or how much hydrogen is still in the fuel cell system. This represents the effectiveness of the purging, which in turn increases the safety during a maintenance operation.

It is further contemplated that the third valve device corresponds to the vent valve of the fuel cell system through which hydrogen flows. This dual use of the valve device ensures a simple and favorable set-up of the fuel cell system. Furthermore, this reduces possible leaks in the fuel cell system.

In the context of the invention, it is optionally possible that the hydrogen sensor in the waste gas line of the cathode circuit measures the hydrogen content of the fuel cell system. The hydrogen content is measured continuously or cyclically.

The content of hydrogen in the separated anode gas can be determined by means of the hydrogen sensor. A low or decreasing content of hydrogen in the anode gas indicates that the fuel cell system is will be or is inerted. This helps to determine safety for maintenance in a more efficient way. At the same time, the duration of the inerting process can be determined.

Furthermore, it may be contemplated in the context of the invention that the purging method is performed up to a hydrogen content of 0.05 to 0.5 vol % as a function of the dilution air mass flow in the waste gas of the waste gas line.

The correlation of the waste gas concentration to the anode gas concentration depends greatly on the dilution air mass flow of the cathode. In this respect, it is a goal to be able to infer a target value of less than 4% in the anode system for the measured hydrogen content in the waste gas.

This content can ensure that the fuel cell system is inert, i.e. that the hydrogen has been replaced by the nitrogen. The lower the hydrogen content, the more effective the purging method. The lower ignition limit is not reached by a hydrogen content in the air of less than 4 vol %.

With respect to the present invention, it is conceivable that a cell voltage of the fuel cell stack is measured, wherein the purging method is measured up to a cell stack voltage less than 60V, preferably less than 45V, further preferably less than 30V, of the fuel cell system.

For this purpose, voltage measuring devices are provided in the fuel cell system. It is contemplated that the control unit may access these voltmeters in order, on the one hand, to display the cell voltage or also adjust the alternating frequency or the target pressure.

The cell voltage can be used to easily determine and/or display the efficiency of the purging method. This increases the safety for the maintenance of the fuel cell system as a low voltage indicates that nitrogen is in the fuel cell system or that the hydrogen content in the fuel cell system is so low that there is no risk of combustion or explosion.

### BRIEF DESCRIPTION OF THE DRAWINGS

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination. The invention is illustrated in the following drawings:

FIG. 1 schematic representation of a fuel cell system with a water separator,

FIG. 2 schematic representation of a fuel cell system with two water separators,

FIG. 3 schematic representation of the purging method for inerting a fuel cell system.

### DETAILED DESCRIPTION

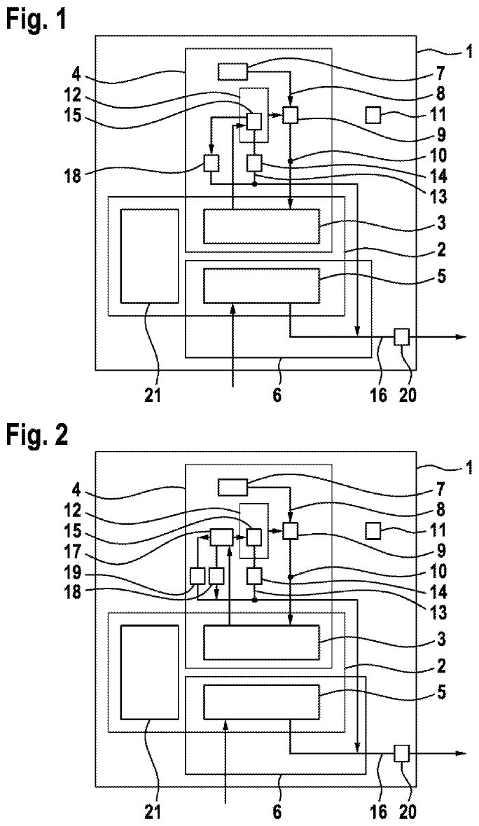

FIG. 1 shows a fuel cell system 1 comprising a fuel cell stack 2 having an anode side 3 with an anode circuit 4 and a cathode side 5 with a cathode circuit 6. Furthermore, a nitrogen tank 7 is shown. The nitrogen tank 7 serves to provide the nitrogen for inerting the fuel cell system 1. For this purpose, a nitrogen supply line 8 with a first valve device 9 is further provided for adjusting the supply of nitrogen from the nitrogen tank 7 to the anode side 3, and a pressure sensor 10, in particular a nitrogen pressure sensor, for adjusting a target pressure p_{Target} in the anode side 3. Furthermore, the fuel cell system 1 comprises a control device 11 which is configured to control the first valve device 9 such that it is cyclically possible to switch between an ambient pressure pamb and the maximum target pressure pTarget.

A gas conveying device 12 is provided for the active conveyance of the nitrogen from the nitrogen tank 7, coming via the first valve device 9, to the anode side 3 of the fuel cell stack 2. Furthermore, the anode circuit 4 provides a water discharge line 13 having a second valve device 14. This serves to discharge separated water from a first water separator 15 of the gas conveying device 12 of the anode circuit 4 in a waste gas line 16 of the cathode circuit 6.

The first water separator 15 separates the water from the gas mixture of the anode side 3. A portion of the gas is supplied and thus discharged via a third valve device 18 of the waste gas line 16 of the cathode circuit 6.

The exemplary embodiment according to FIG. 2 comprises an additional second water separator 17 and an additional fourth valve device 19. This then initially separates a first part of the water of the anode circuit 4 downstream the anode and delivers the remaining anode gas to the gas conveying device 12 or the first water separator 15 of the gas conveying device 12. The third valve device 18 and the fourth valve device 19 are thereby associated with the second water separator 17. And the fourth valve device 19 discharges the water into the waste gas line 16 of the cathode circuit 6.

The fuel cell systems 1 of FIGS. 1 and 2 provide a hydrogen sensor 20 in the waste gas line 16 of the cathode circuit 6 to measure the hydrogen content in the waste gas. This provides information on the state of inertization. Furthermore, voltage measuring devices 21 are provided, since the cell voltage also shows the progress. The lower the cell voltage, the safer it is to perform maintenance.

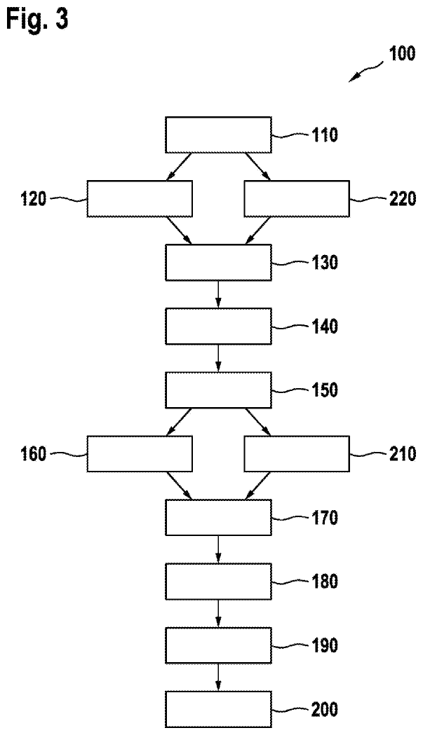

FIG. 3 shows the purging method 100 for inerting a fuel cell system 1 according to FIG. 1 or FIG. 2, comprising the steps of:
switching 110 a gas source of the anode circuit 4 of the fuel cell stack 2 from hydrogen to nitrogen,
commissioning 120 the gas conveying device 12, in particular a flow compressor, for conveying nitrogen into the anode circuit 4,
commissioning 220 the cathode circuit 6 for generating the diluting air in the exhaust gas,
opening 130 the first valve device 9 in the nitrogen supply line 8 of the anode circuit 4,
adjusting 140 the target pressure by means of the first valve device 9 of the nitrogen supply line 8 on the anode side 3 of the fuel cell stack 2,
opening 150 the second valve device 14 of the water discharge line 13 of the anode circuit 4 for discharging the separated water of the first water separator of the gas conveying means 12 into the waste gas line 16 of the cathode circuit 6,
cyclical switching 160 of the target pressure p_{Target}, wherein the target pressure p_{Target} is switched between the maximum target pressure p_{Target} and the ambient pressure p_{amb},

Cyclical opening and closing 210 of the second valve device.

The cyclical switching is carried out at an alternating frequency of between 0.5 and 10 Hz. In addition, the operation of the gas conveying device 12 is changed cyclically. In this case, the gas conveying device 12 can be changed between various operating conditions or power levels or even switched off or on.

The maximum target pressure p_{Target} is a relative pressure, that is, it is set relative to the ambient pressure p_{amb} and the cathode pressure, wherein the target pressure is set to 0.3-5 bar relative to the ambient pressure p_{amb}. Furthermore, the target pressure of the anode deviates from the cathode pressure by a maximum of 1 bar.

Simultaneously or subsequently, the third valve device 18 of the water discharge line 13 of the anode circuit 4 is opened 170 to discharge the anode gas of the first water separator of the gas conveying device 12 into the waste gas line 16 of the cathode circuit 6. In addition, the fourth valve device 19 of the water draining line 13 of the anode circuit 4 is opened 180 to discharge the water into the waste gas line 16 of the cathode circuit 6.

Furthermore, the hydrogen content of the fuel cell system 1 is measured 190 by means of the hydrogen sensor 20 in the waste gas line 16 of the cathode circuit 6. The hydrogen content is measured continuously 190. Once a hydrogen content of 0.5 vol % is measured as a function of the dilution air mass flow in the waste gas of the waste gas line 16, the fuel cell system 1 is considered inert.

Furthermore, the cell voltage of the fuel cell stack 2 is measured 200 by means of the voltage measuring devices 21. The purging method is carried out until a cell stack voltage of less than 60V is measured.

1. A fuel cell system (1) comprising a fuel cell stack (2) having an anode side (3) with an anode circuit (4), and a cathode side (5) with a cathode circuit (6), a nitrogen tank (7) for providing nitrogen for inerting the fuel cell system (1), a nitrogen supply line (8) having a first valve device (9) for adjusting the supply of nitrogen from the nitrogen tank (7) to the anode side (3), and a pressure sensor (10) for adjusting a target pressure (p_{Target}) to the anode side (3), wherein a control device (11) of the fuel cell system (1) is configured to control the first valve device (9) such that there can be cyclical switching between an ambient pressure (_{pamb}) and a maximum target pressure (p_{Target}), a gas conveying device (12), which is configured to actively convey the nitrogen coming from the nitrogen tank (7) to the anode side (3) of the fuel cell stack (2) via the first valve device (9), a water discharge line (13) having a second valve device (14) for discharging separated water from a first water separator (15) of the gas conveying device (12) of the anode circuit (4) into a waste gas line (16) of the cathode circuit (6).

2. The fuel cell system (1) according to claim 1,
wherein
a third valve device (18) is provided for discharging anode gas from a first water separator (15) of the anode circuit (4) into a waste gas line (16) of the cathode circuit (6).

3. The fuel cell system (1) according to claim 1,
wherein
a hydrogen sensor (20) is provided in the waste gas line (16) of the cathode circuit (6).

4. A purging method (100) for inerting a fuel cell system (1) with nitrogen according to claim 1, comprising the steps of:
switching (110) a gas source of the anode circuit (4) of the fuel cell stack (2) from hydrogen to nitrogen,
commissioning (120) the gas conveying device (12) for conveying nitrogen into the anode circuit (4),
commissioning (220) the cathode circuit (6) for generating the diluting air in the waste gas,
opening (130) the first valve device (9) in the nitrogen supply line (8) of the anode circuit (4),
adjusting (140) the target pressure (p_{Target}) by means of the first valve device (9) of the nitrogen supply line (8) on the anode side (3) of the fuel cell stack (2),
opening (150) the second valve device (14) of the water discharge line (13) of the anode circuit (4) for discharging the separated water of the first water separator of the gas conveying device (12) into the waste gas line (16) of the cathode circuit (6),
cyclical switching (160) of the target pressure, wherein the target pressure (p_{Target}) is switched between the maximum target pressure (p_{Target}) and the ambient pressure (p_{amb}) and/or cyclical switching the gas conveying device (12) on and off.

5. The purging method (100) according to claim 4,
wherein
the cyclical switching (160) is performed at an alternating frequency, wherein the alternating frequency is 0.5 to 10 Hz, preferably 2 to 8 Hz, further preferably 3 to 7 Hz.

6. The purging method (100) according to claim 4,
wherein
cyclical switching (220) between different operating states of the gas conveying device is performed.

7. The purging method (100) of claim 4,
wherein
the maximum target pressure (p_{Target}) is adjusted relative to the ambient pressure (p_{amb}), wherein the target pressure (p_{Target}) is set at 0.3 to 5 bar, preferably 1 to 4 bar, further preferably 1.5 to 3 bar, relative to the ambient pressure (p_{amb}), and/or adjusted relative to the cathode pressure, wherein the target pressure (p_{Target}) deviates by a maximum of 1 bar from the cathode pressure.

8. The purging method (100) according to claim 4,
wherein
the third valve device (18) of the water discharge line (13) of the anode circuit (4) is opened (170) to discharge the anode gas of the first water separator of the gas conveying device (12) into the waste gas line (16) of the cathode circuit (6).

9. The purging method (100) according to claim 4,
wherein
the hydrogen sensor (20) in the waste gas line (16) of the cathode circuit (6) measures (190) the hydrogen content of the fuel cell system (1).

10. The purging method (100) according to claim 4,
wherein
the purging method is performed up to a hydrogen content of 0.05 to 0.5 vol % as a function of the dilution air mass flow in the waste gas of the waste gas line (16).

11. The purging method (100) according to claim 4,
wherein
a cell voltage of the fuel cell stack (2) is measured (200), wherein the purging method is measured up to a cell stack voltage less than 60V, preferably less than 45V, further preferably less than 30V, of the fuel cell system (1).
